(19) United States
(12) Patent Application Publication
(10) Pub. No.: US 2017/0010236 A1
(43) Pub. Date: Jan. 12, 2017

(54) HEATER CONTROL DEVICE FOR EXHAUST GAS SENSOR

(71) Applicant: DENSO CORPORATION, Kariya-city, Aichi-pref. (JP)

(72) Inventors: Yoshihiro SAKASHITA, Kariya-city (JP); Yukihiro YAMASHITA, Kariya-city (JP); Ryozo KAYAMA, Kariya-city (JP)

(21) Appl. No.: 15/120,629

(22) PCT Filed: Apr. 8, 2015
(86) PCT No.: PCT/JP2015/001981

§ 371 Date: Aug. 22, 2016

(30) Foreign Application Priority Data
Apr. 23, 2014 (JP) 2014-089291

(51) Int. Cl. G01N 27/406; F01N 11/00; G01N 27/409; F01N 9/00

(52) U.S. Cl. CPC G01N 27/4067; F01N 9/00; F01N 11/007; F01N 11/002; G01N 27/409

(57) ABSTRACT

An exhaust gas sensor includes a sensor element having a plurality of cells, and a heater heating the sensor element. A heater control device for the exhaust gas sensor includes a heater power control unit that performs an impedance control, in which an energization of the heater is controlled by detecting an impedance of one cell to be measured, of the plurality of cells, such that the impedance of the one cell agrees with a target impedance. The heater power control unit, in the impedance control, estimates a temperature of the other cell other than the one cell based on at least one parameter of an energization condition of the heater and an operating condition of the internal-combustion engine, and corrects the target impedance so that the temperature of the other cell becomes lower than or equal to a permissible upper limit temperature.

### CROSS REFERENCE TO RELATED APPLICATION

This application is based on Japanese Patent Application No. 2014-89291 filed on Apr. 23, 2014, the disclosure of which is incorporated herein by reference.

### TECHNICAL FIELD

The present disclosure relates to a heater control device for an exhaust gas sensor including a sensor element having a plurality of cells and a heater heating the sensor element.

### BACKGROUND ART

An air/fuel ratio is electronically controlled based on an output of an exhaust gas sensor disposed in an exhaust pipe, for an internal-combustion engine, in recent years. Generally, the detection accuracy is low (or the detection fails) when the temperature of a sensor element is lower than an active temperature, in the exhaust gas sensor. Therefore, the sensor element is heated by a heater arranged in the exhaust gas sensor, after starting an internal-combustion engine, to activate the exhaust gas sensor.

An exhaust gas sensor (for example, NOx sensor) is known, which includes a sensor element with plural cells. An impedance (internal resistance) of one cell to be measured of the plural cells is detected as temperature information. An energization of a heater is controlled such that the impedance of the one cell agrees with a target impedance, in a system controlling the temperature of the sensor element. In Patent Literature 1, the energization of a heater is controlled so that a resistance of a cell to be measured becomes equal to a first predetermined resistance. Then, the energization of the heater is controlled further such that the resistance of the cell to be measured becomes equal to a second predetermined resistance larger than the first predetermined resistance.

### PRIOR ART LITERATURES

### Patent Literature

Patent Literature 1: JP 2009-69140 A

### SUMMARY OF INVENTION

According to research of the Applicant, a relation between the temperature of the cell to be measured and the temperature of the other cell is not fixed when the temperature of the cell to be measured and the temperature of the other cell change. Heat transmission characteristics is different between the one cell to be measured and the other cell depending on the condition at that time (for example, electric power of heater, or exhaust gas temperature). The relation between the temperature of the cell to be measured and the temperature of the other cell changes based on the condition. That is, even when the temperature (impedance) of the cell to be measured is the same, the temperature of the other cell changes depending on the condition at that time. For this reason, even if the energization of a heater is controlled so that the impedance of the cell to be measured agrees with the target impedance set in advance, depending on the conditions, the temperature of the other cell may exceed a permissible upper limit temperature. If the temperature of the other cell exceeds the permissible upper limit temperature, the other cell may be damaged by overheating.

It is an object of the present disclosure to provide a heater control device in which a temperature of the other cell other than a cell to be measured (impedance of the cell is detected) is prevented from exceeding a permissible upper limit temperature for an exhaust gas sensor including a sensor element with the plural cells.

According to an aspect of the present disclosure, a heater control device for an exhaust gas sensor disposed in an exhaust gas passage of an internal-combustion engine and including a sensor element having a plurality of cells and a heater heating the sensor element includes a heater power control unit. The heater power control unit performs an impedance control, in which an energization of the heater is controlled by detecting an impedance of one cell to be measured, of the plurality of cells, such that the impedance of the one cell agrees with a target impedance. The heater power control unit, in the impedance control, estimates a temperature of the other cell other than the one cell based on at least one parameter of an energization condition of the heater and an operating condition of the internal-combustion engine, and corrects the target impedance so that the temperature of the other cell becomes lower than or equal to a permissible upper limit temperature.

In this way, the target impedance can be changed so that the temperature of the other cell becomes lower than or equal to the permissible upper limit temperature, even if the relation between the temperature (impedance) of the one cell to be measured and the temperature of the other cell is changed by the energization condition of the heater or the operating condition of the internal-combustion engine in the impedance control. Therefore, the temperature of the other cell can be prevented from exceeding the permissible upper limit temperature, and the other cell can be prevented from damaged by overheating.

### BRIEF DESCRIPTION OF DRAWINGS

FIG. 1 is a schematic view illustrating an engine control system according to an embodiment of the present disclosure;

FIG. 2 is a sectional view illustrating a sensor element;

FIG. 3 is a cross-sectional view taken along a line in FIG. 2;

FIG. 4 is a time chart illustrating a temperature of a sensor cell when a target impedance is not corrected;

FIG. 5 is a time chart illustrating a temperature of a sensor cell when a target impedance is corrected; and

FIG. 6 is a flow chart illustrating a processing of a heater energization control routine.

### DESCRIPTION OF EMBODIMENTS

Hereinafter, an embodiment will be described according to the drawings.

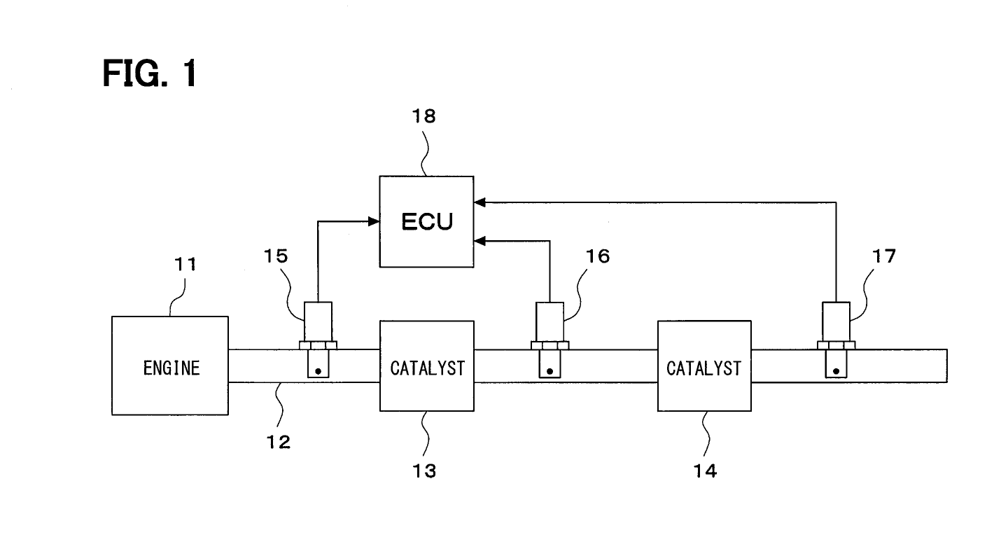

A schematic configuration of an engine control system is described with reference to FIG. 1.

An engine 11, which is an internal combustion engine, is provided with an exhaust pipe 12 (an exhaust gas passage), and the exhaust pipe 12 is provided with an upstream catalyst 13 and a downstream catalyst 14, which may be three-way catalysts for removal of CO, HC, NOₓ, and the like from an exhaust gas. An air-fuel ratio sensor 15 is disposed upstream of the upstream catalyst 13 to detect the air-fuel ratio of the exhaust gas. An oxygen sensor 16 is placed downstream of the upstream catalyst 13 (between the upstream catalyst 13 and the downstream catalyst 14) to determine the richness/leanness of the exhaust gas. A NOₓ sensor 17 is disposed downstream of the downstream catalyst 14 to detect the concentration of NOₓ in the exhaust gas.

The outputs of the sensors 15, 16, and 17 are input to an electronic control unit (hereinafter referred to as ECU) 18. The ECU 18 includes a microcomputer, which is its main component, and controls fuel injection quantity, ignition timing, throttle opening (intake air quantity), and other factors in accordance with the operating state of the engine by executing various engine control programs stored in a built-in ROM (a storage medium).

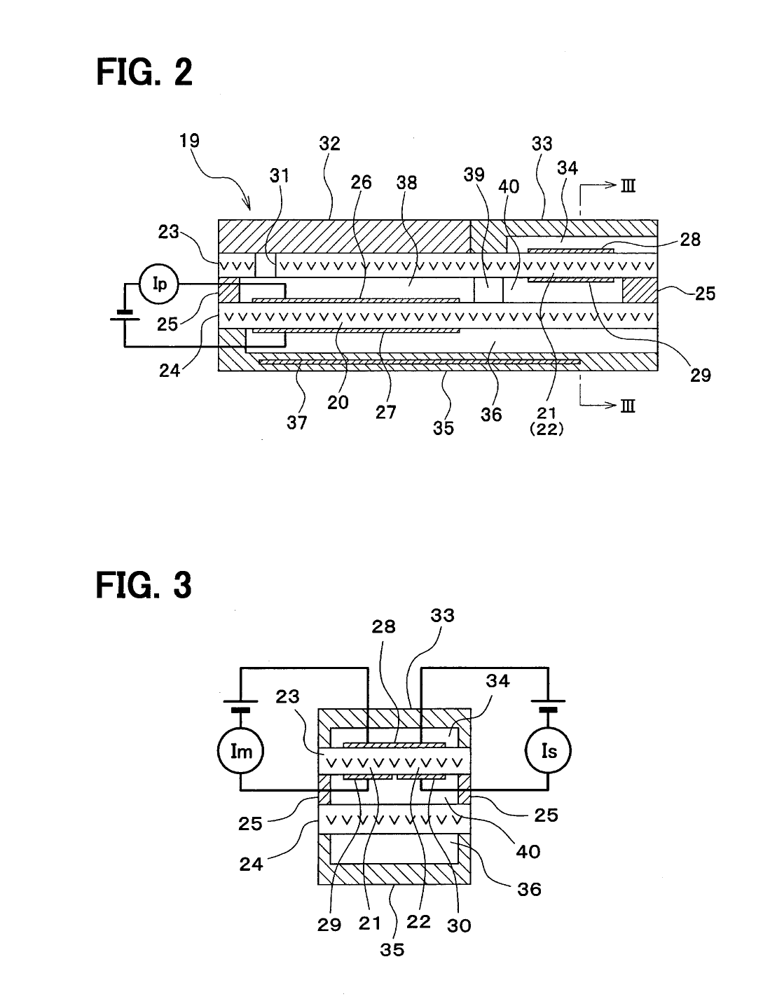

With reference to FIGS. 2 and 3, a schematic configuration of a sensor element 19 of the NOₓ sensor 17 is described below.

The sensor element 19 of the NOₓ sensor 17 has a three cell structure including a pump cell 20, a monitor cell 21, and a sensor cell 22. The sensor element 19 includes layers of first and second solid electrolytes 23 and 24, which are made of an oxygen ion conductive material, and a spacer 25, which is made of an insulating material, such as alumina. The first and second solid electrolytes 23 and 24 are spaced apart from each other by a predetermined interval with the spacer 25 interposed between the first and second solid electrolytes 23 and 24.

The pump cell 20 includes the second solid electrolyte 24 and a pair of electrodes 26 and 27, with the second solid electrolyte 24 interposed between the electrodes 26 and 27. The monitor cell 21 includes the first solid electrolyte 23 and a pair of electrodes 28 and 29, with the first solid electrolyte 23 interposed between the electrodes 28 and 29. The sensor cell 22 includes the first solid electrolyte 23, the electrode 28, and an electrode 30, with the first solid electrolyte 23 interposed between the electrodes 28 and 30. That is, the monitor cell 21 and the sensor cell 22 share the electrode 28.

The first solid electrolyte 23 has a pinhole 31. A porous diffusion layer 32 is placed on an upper surface of the first solid electrolyte 23 where the pump cell 20 is located. An insulating layer 33 is placed on the upper surface of the first solid electrolyte 23 where the monitor cell 21 and the sensor cell 22 are located. The insulating layer 33 forms an atmosphere passage 34. An insulating layer 35 is placed on a lower surface of the second solid electrolyte 24. The insulating layer 35 forms an atmosphere passage 36. The insulating layer 35 includes a heater 37 therein to heat up the sensor element 19.

The exhaust gas in the exhaust pipe 12 passes through the porous diffusion layer 32 and the pinhole 31 formed in the solid electrolyte 23 to enter a first chamber 38. The pump cell 20 discharges or draws oxygen in the exhaust gas relative to the first chamber 38 and detects an oxygen concentration in the exhaust gas. Then, the exhaust gas in the first chamber 38 passes through an orifice 39 into a second chamber 40. The monitor cell 21 detects an oxygen concentration (a residual oxygen concentration) in the exhaust gas in the second chamber 40. The sensor cell 22 detects a NOₓ concentration in the exhaust gas in the second chamber 40.

The NOₓ sensor 17 generally exhibits poor sensing precision (or fails to function) before the sensor element 19 (at the cells 20 to 22) achieves activation temperatures. Thus, the ECU 18 controls power to the heater 37 inside the NOₓ sensor 17 to heat up and thereby activate the sensor element 19.

Specifically, after the start of the engine 11, it is determined whether the inside of the exhaust pipe 12 is dry (whether moisture in the exhaust pipe 12 has been vaporized). When it is determined that the inside of the exhaust pipe 12 is not dry, since moisture may be on the exhaust pipe 12 and the NOₓ sensor 17, preheating control is executed. In the preheating control, the power to the heater 37 is controlled such that the sensor element 19 of the NOₓ sensor 17 is preheated in a temperature range in which no crack due to water is caused to the element. In the preheating control, the sensor element 19 is preheated with a power duty (a power control value) of the heater 37 set to a preheating power duty (for example, 10%).

Subsequently, when it is determined that the inside of the exhaust pipe 12 is dry, heating control is executed in which the power to the heater 37 is controlled such that the temperature of the sensor element 19 is increased quickly. In the heating control, the sensor element 19 is heated with the power duty of the heater 37 set to a heating power duty (for example, 100%).

Further, an impedance Zp of the pump cell 20 (a cell to be measured) is detected. It is determined whether the pump cell 20 is activated (whether it has achieved its activation temperature) in accordance with whether the impedance Zp of the pump cell 20 is smaller than an activity determination impedance Zp1 (a value corresponding to the activation temperature of the pump cell 20).

When the impedance Zp of the pump cell 20 become smaller than the activity determination impedance Zp1, it is determined that the pump cell 20 has been activated, and the impedance control is performed in which the energization of the heater 37 is controlled to maintain the active state of the sensor element 19. In the impedance control, a feedback control is performed relative to the energization duty of the heater 37 so that the impedance Zp of the pump cell 20 agrees with the target impedance TZ. Specifically, the energization duty of the heater 37 is computed by using, for example, PI control so as to reduce the deviation between the impedance Zp of the pump cell 20 and the target impedance TZ.

Heat transmission characteristics is different between the pump cell 20 and the sensor cell 22 depending on the condition at that time (such as electric power supplied to the heater, or exhaust gas temperature). The temperature of the pump cell 20 and the temperature of the sensor cell 22 do not always maintain a fixed relation. The relation between the temperature of the pump cell 20 and the temperature of the sensor cell 22 changes depending on the conditions. That is, even when the temperature (impedance) of the pump cell 20 is the same, the temperature of the sensor cell 22 changes depending on the conditions at that time.

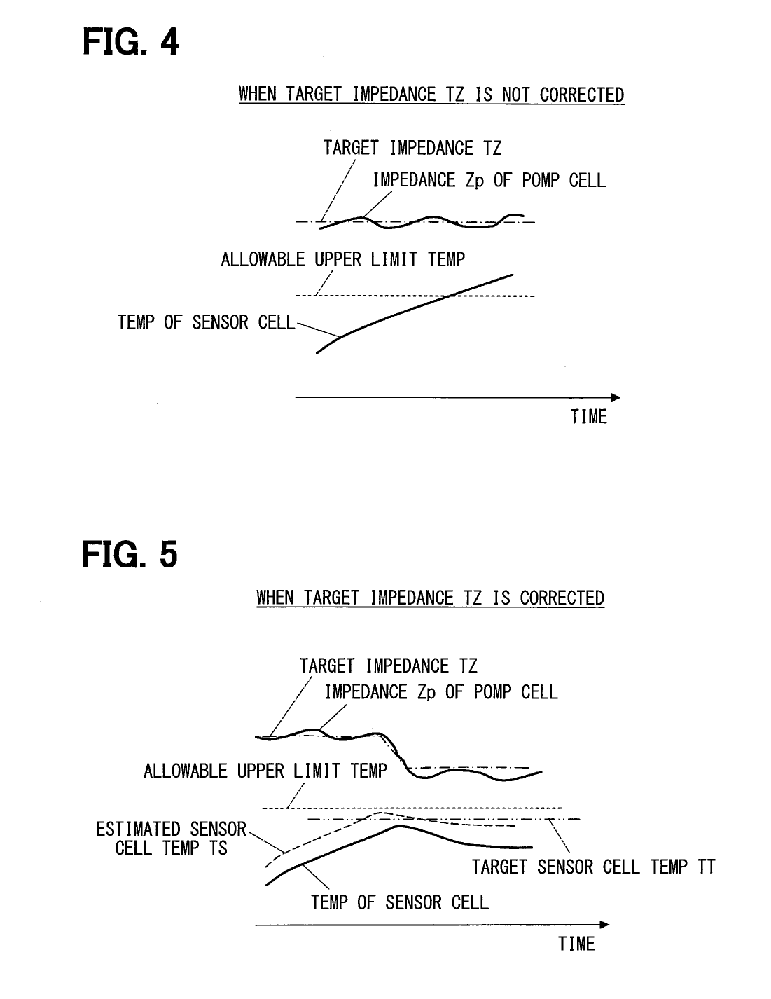

For this reason, as shown in FIG. 4, even when the power supply to the heater 37 is controlled such that the impedance Zp of the pump cell 20 agrees with the target impedance TZ, the temperature of the sensor cell 22 may exceed a permissible upper limit temperature, depending on the conditions. When the temperature of the sensor cell 22 exceeds the permissible upper limit temperature, there is a possibility that the sensor cell 22 may be damaged by overheating.

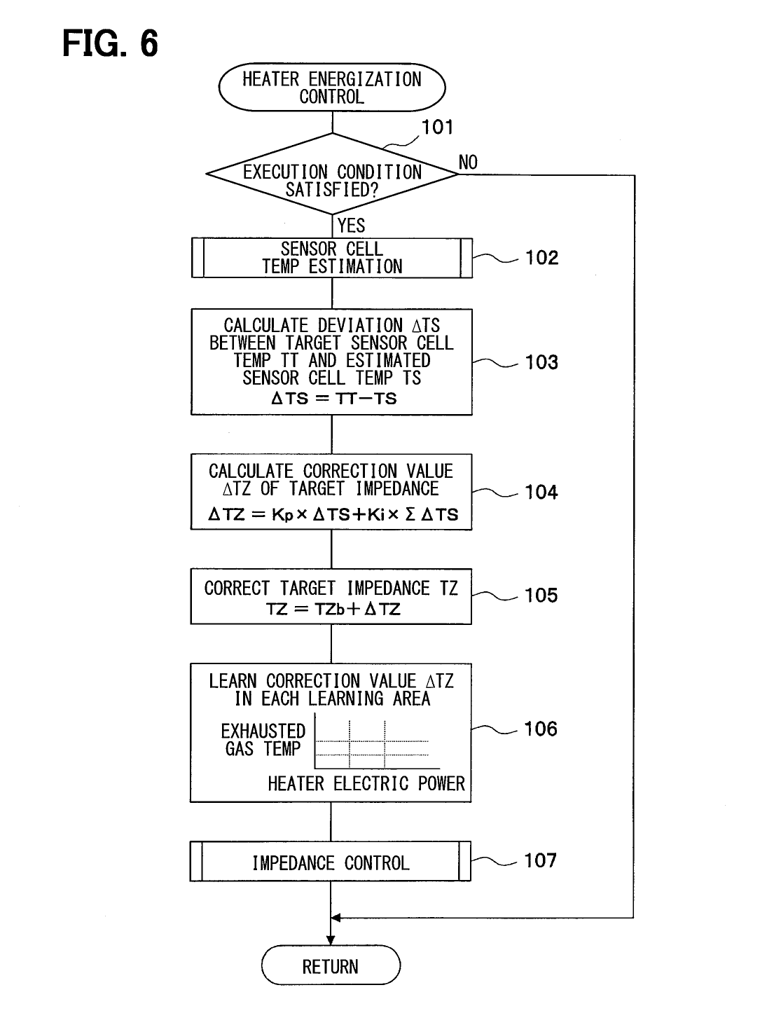

In this embodiment, ECU 18 executes a heater energization control routine of FIG. 6 to be mentioned later as follows.

As shown in FIG. 5, in the impedance control, the temperature of the sensor cell 22 is estimated based on at least one parameter of the energization condition of the heater 37 and the operating condition of the engine 11 (for example, the electric power of the heater 37 or the exhaust gas temperature of the engine 11). The target impedance TZ is corrected so that the estimated sensor cell temperature TS which is an estimated temperature of the sensor cell 22 becomes lower than or equal to a permissible upper limit temperature. Specifically, the correction value ΔTZ of the target impedance is computed by using PI control so as to reduce a deviation ΔTS between the target sensor cell temperature TT (for example, temperature slightly lower than the permissible upper limit temperature of the sensor cell 22) and the estimated sensor cell temperature TS, and the target impedance TZ is corrected using the correction value ΔTZ.

Thereby, in the impedance control, even if the relation between the temperature (impedance) of the pump cell 20 and the temperature of the sensor cell 22 is changed by the energization condition of the heater 37 or the operating condition of the engine 11, the target impedance TZ can be changed so that the temperature of the sensor cell 22 becomes lower than or equal to the permissible upper limit temperature.

The processing of the heater energization control routine executed by ECU 18 is described with reference to FIG. 6.

The heater energization control routine shown in FIG. 6 is repeatedly performed at a predetermined cycle while power is supplied to ECU 18, and corresponds to a heater power control unit.

When the routine is started, it is determined whether a predetermined execution condition is satisfied at Step 101, based on, for example, whether the warm-up of the engine 11 is finished (whether the temperature of cooling water is higher than or equal to a predetermined value) or whether the impedance Zp of the pump cell 20 is smaller than the activity determination impedance Zp1. When it is determined that the execution condition is not satisfied at Step 101, the routine is ended without performing processing after Step 102.

When it is determined that the execution condition is satisfied at Step 101, ECU progresses to Step 102 where the temperature of the sensor cell 22 is estimated (calculated) based on the energization condition of the heater 37 and the operating condition of the engine 11. In this case, the estimated sensor cell temperature TS (estimation value of the temperature of the sensor cell 22) is computed according to for example, the electric power of the heater 37 and the exhaust gas temperature of the engine 11 using a map or mathematical formula. At this time, the exhaust gas temperature may be estimated based on engine operational status (for example, engine revolving speed, load, etc.), or may be detected with a temperature sensor. The map or mathematical formula for the estimated sensor cell temperature TS is beforehand set based on examination data, design data, etc., and is memorized by ROM of ECU 18.

Then, ECU progresses to Step 103 to calculate the deviation ΔTS between the target sensor cell temperature TT and the estimated sensor cell temperature TS.

ΔTS=TT−TS (formula 1)

The target sensor cell temperature TT is set as a temperature, for example, slightly lower than the permissible upper limit temperature of the sensor cell 22 (refer to FIG. 5).

Then, ECU progresses to Step 104, the correction value ΔTZ of the target impedance is computed by using, for example, PI control so as to reduce the deviation ΔTS of the target sensor cell temperature TT and the estimated sensor cell temperature TS.

ΔTZ=Kp×ΔTS+Ki×ΣΔTS (formula 2)

Kp is a proportionality gain and Ki is an integration gain.

Then, ECU progresses to Step 105 to calculate the target impedance TZ by adding the correction value ΔTZ to the base value TZb of the target impedance, such that the target impedance TZ is corrected using the correction value ΔTZ.

TZ=TZb+ΔTZ (formula 3)

Then, ECU progresses to Step 106 to learn the correction value ΔTZ of the target impedance as follows in each learning area defined according to the energization condition of the heater 37 and the operating condition of the engine 11 (for example, the electric power of the heater 37 or the exhaust gas temperature of the engine 11).

The map of the learned values of the correction value ΔTZ is memorized in a rewritable nonvolatile memory such as backup RAM of ECU 18 (rewritable memory which holds memory data when power is not supplied to ECU 18). The map of the learned values of the correction value ΔTZ is divided into plural learning areas defined based on parameters such as the electric power of the heater 37 and the exhaust gas temperature of the engine 11. The learned values of the correction value ΔTZ are memorized in each learning area. In the map of the learned values of the correction value ΔTZ, the present learned value of the correction value ΔTZ in the learning area corresponding to the electric power of the heater 37 and the exhaust gas temperature of the engine 11 is updated by the present correction value ΔTZ.

Then, ECU progresses to Step 107 and the impedance control is performed. In the impedance control, feedback control is carried out relative to the energization duty of the heater 37 so that the impedance Zp of the pump cell 20 agrees with the target impedance TZ. Specifically, the energization duty of the heater 37 is computed by PI control so as to reduce the deviation between the impedance Zp of the pump cell 20 and the target impedance TZ.

According to the embodiment, in the impedance control, the temperature of the sensor cell 22 is estimated based on the energization condition of the heater 37 and the operating condition of the engine 11 (for example, the electric power of the heater 37, and the exhaust gas temperature of the engine 11), and the target impedance is corrected so that the estimation value of the temperature of the sensor cell 22 (estimated sensor cell temperature) becomes lower than or equal to the permissible upper limit temperature. Thus, in the impedance control, even if the relation between the temperature (impedance) of the pump cell 20 and the temperature of the sensor cell 22 is changed by the energization condition of the heater 37 or the operating condition of the engine 11, the target impedance can be changed so that the temperature of the sensor cell 22 becomes lower than or equal to the permissible upper limit temperature. Thereby, the temperature of the sensor cell 22 can be prevented from exceeding the permissible upper limit temperature. The sensor cell 22 can be prevented from being damaged by overheating.

According to the embodiment, the correction value of the target impedance is learned in each learning area defined according to the energization condition of the heater 37 and the operating condition of the engine 11 (for example, the electric power of the heater 37 and the exhaust gas temperature of the engine 11). Thus, a proper correction value (correction value which makes the temperature of the sensor cell 22 to be lower than or equal to the permissible upper limit temperature) can be learned based on the energization condition of the heater 37 and the operating condition of the engine 11 in each learning area correspondingly to the change in the proper correction value of the target impedance. Thereby, the target impedance can be corrected using the learning value (the correction value learned last time) of the corresponding learning area, even before the correction value of the target impedance is newly computed (or incomputable), in the impedance control.

According to the embodiment, the temperature of the sensor cell 22 is estimated using the electric power of the heater 37 and the exhaust gas temperature of the engine 11. When the amount of heat received by the sensor cell 22 changes depending on the electric power of the heater 37 and the exhaust gas temperature, the temperature of the sensor cell 22 changes. Therefore, the temperature of the sensor cell 22 can be accurately estimated using the electric power of the heater 37 and the exhaust gas temperature.

According to the embodiment, the temperature of the sensor cell 22 is estimated based on the energization condition of the heater 37 and the operating condition of the engine 11 (for example, the electric power of the heater 37, and the exhaust gas temperature of the engine 11). However, the method of presuming the temperature of the sensor cell 22 is not limited to this, and may be changed suitably. For example, the temperature of the sensor cell 22 may be estimated only based on one of the energization condition of the heater 37 and the operating condition of the engine 11.

The energization condition of the heater 37 is not limited to the electric power of the heater 37. For example, the integral power consumption or energization duty of the heater 37 may be used. Moreover, the operating condition of the engine 11 is not limited to the exhaust gas temperature of the engine 11. For example, the revolving speed, load, or flow rate of exhaust gas of the engine 11 may be used.

The present disclosure may be implemented by being applied to various exhaust gas sensors (for example, air/fuel ratio sensor) including the sensor element with the plural cells, not limited to a NOₓ sensor.

1. A heater control device for an exhaust gas sensor disposed in an exhaust gas passage of an internal-combustion engine and including a sensor element having a plurality of cells, and a heater heating the sensor element, the heater control device comprising:
a heater power control unit that performs an impedance control, in which an energization of the heater is controlled by detecting an impedance of one cell to be measured, of the plurality of cells, such that the impedance of the one cell agrees with a target impedance, wherein
the heater power control unit, in the impedance control, estimates a temperature of the other cell otherthan the one cell based on at least one parameter of an energization condition of the heater and an operating condition of the internal-combustion engine, and corrects the target impedance so that the temperature of the other cell becomes lower than or equal to a permissible upper limit temperature.

2. The heater control device according to claim 1, wherein
the heater power control unit learns a correction value of the target impedance in each learning area that is defined based on the parameter.

3. The heater control device according to claim 1, wherein
the heater power control unit estimates the temperature of the other cell using an electric power of the heater and an exhaust gas temperature of the internal-combustion engine as the parameter.
